(19) United States
(12) Patent Application Publication
(10) Pub. No.: US 2010/0017532 A1
(43) Pub. Date: Jan. 21, 2010

(54) TRANSPORT STREAM MIGRATION METHOD AND SYSTEM

(75) Inventor: Gareth Bowen, Hampshire (GB)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS Limited, Staines, Middlesex (GB)

(21) Appl. No.: 12/312,309

(22) PCT Filed: Nov. 27, 2006
(86) PCT No.: PCT/GB2006/004419

§ 371 Date: Jun. 2, 2009

(51) Int. Cl. G06F 15/16

(52) U.S. Cl. 709/231; 709/248

(57) ABSTRACT

A transport stream migration method is described. The transport stream migration method includes providing a live server (17A) and a target server (19), the live server (17A) receiving a transport stream, designating exactly one of the live server (17A) and the target server (19) as a controlling server, the controlling server receiving a migration instruction, the target server (19) receiving a copy of the transport stream, negotiating a synchronization point by the live server (17A) and the target server (19), and migrating output of the transport stream from the live server (17A) to the target server (19) with respect to a time determined from the synchronization point negotiated. Related apparatus and systems are also described.

### FIELD OF THE INVENTION

The present invention relates to transport stream migration mechanisms for streaming TV content over IP networks.

### BACKGROUND OF THE INVENTION

Internet protocol-television (IPTV) is a distribution system for TV content over IP-based networks. Previously, this content has been carried over other mediums (e.g. satellite, cable) and standards exist describing the transportation of content (in “transport streams”). In IPTV, the content is carried over an IP-based network, for example, using user datagram protocol (UDP) and possibly multicast (for efficiency purposes). IPTV management systems known in the art are used to configure and monitor the servers and server workgroups delivering content to users. They are also used to create and maintain the network channels over which the incoming streams are played out. Other tasks may include the generation and modification of conditional access (CA) criteria to be applied to incoming streams and adding individual CA events to channel schedules. Such systems are generally physically comprised of hardware and software installed on a server. The hardware fitted varies from system to system according to the interfaces and features required by each content provider. An exemplary system, known in the art, is StreamShaper™ (commercially available from NDS Limited, 1 Heathrow Boulevard, 286 Bath Road, West Drayton, Middlesex UB7 0DQ, UK).

Such IPTV delivery systems may be used for translation, for example, of MPEG-2, MPEG-4 and AC3 elementary streams contained in an MPEG-2 transport stream from a broadcast environment (e.g. where the content is already made available to satellite delivery equipment) to an IP environment. (MPEG-2 is an industry standard for video and audio source coding that is also known as ISO/IEC 13818[1]. MPEG-4 is also known as ISO 14496-2. AC3 is an industry standard for audio encoding defined by the advanced television systems committee.) In an exemplary preferred embodiment, translation from a broadcast environment to an IP environment comprises receiving an MPEG-2 transport stream from a DVB-ASI (digital video broadcasting-asynchronous serial interface) source, decrypting and/or encrypting selected services (where content protection is used), and then streaming them over an IP network to set-top boxes where the services can be viewed. In an alternative preferred embodiment, such IPTV delivery systems may act as a gateway between IP networks.

Set-top boxes may be IP enabled Content protection can be applied to individual services to restrict viewing to suitably entitled subscribers. Persons skilled in the art will appreciate that set-top boxes are named by their usual location on top of a television set, but that the term “set-top box” is not meant to limit the location of the set-top box relative to a television set with which the set-top box is associated, it being further appreciated that televisions with integrated set-top box functionality are also known in the art.

One of the major problems facing manufacturers of equipment systems used for television content delivery is the ability to provide non-stop, uninterrupted operation all the time (true 24X7 service), such that there are no picture glitches in the event of equipment failure or upgrades. This is a problem whether content is digitally broadcast or delivered on IP networks. IPTV delivery systems known in the art generally support failover mechanisms such that if a server cannot stream, another server will take over as soon as possible. Exemplary reasons why a server may not be able to stream comprise a fatal software crash, lost connection with the conditional access system, routine maintenance and/or upgrade to the server, an operating system patch, etc.

The system latency (the time taken for data to propagate from the input to the output of the server) on a stream is configurable but is generally at least one second (as this gives a good balance between excessive delay and the ability of the server to smooth out bursted input). The process of failover is reactive, i.e. once the error has been detected on the live server, the server is stopped, and the target machine(s) takes over. Therefore, there is always a minimum service outage equal to the system latency. Additionally, the conditional access system is not able to activate instantly. Typically, at least two seconds will elapse before control words and entitlement control messages (ECMs) arrive at the target machine when using CA systems such as Videoguard™ (commercially available from NDS Limited). This delay may be closer to ten seconds if a large number of channels are serviced. Even once the control words have arrived, it is not possible to start streaming immediately since ECMs must stream for some period of time before the control word can be used; a typical safe period is one second. The delay before content streaming begins may be necessary to give the set-top box (STB) sufficient time to generate the control word for that ECM in order to decrypt the content. Finally, the control word can only be activated on an I-frame (up to a 0.5 second delay in a typical MPEG-2 video elementary stream). Summing all of these delays means that the whole process can result in an outage of ten seconds or more.

When a server suddenly fails (software or hardware) and is no longer able to stream, there is little that can be done to avoid the ten second delay. When a server is properly streaming content, content providers may be reluctant to do anything to interrupt. Potentially this reluctance could delay maintenance and/or upgrades. Additionally, if the server is running on PC hardware and connected to a network, virus protection software may need to be run. Running of virus protection software may interfere with the behavior of the server and would therefore generally be run as a scheduled task preferably, when the server is not streaming.

In a small installation, a “dual hot” failover configuration can be used. In this situation, two servers will both stream the same transport streams into the same IP network switch. The failover management system will use the network switch to control which server is live (in other words, which server's transport streams are delivered) and which is the target (or back up). At a point of failure the failover management system will change the configuration of the switch so that the output of the target server is used instead of the output of the live server. One difficulty with this approach is that at the changeover point, while the underlying content is the same, the encryption applied may not be. Therefore, there is generally a delay since the STB must wait for the first ECM after the changeover and then for the first I-frame to begin decryption/decoding. With an ECM carousel rate of one second (the typical default for a Synamedia™ IPTV deployment, commercially available from NDS Limited) and 0.5 seconds between I-frames (the typical gap in MPEG-2 video streams), the delay can be anything up to 1.5 seconds. The delay may be considerably longer if the polarity of the control word on the two servers is the same but the control words are not. In this situation, the STB would need to wait for the next control word (typically 10 seconds between control word changes). This also assumes that the control software and/or switch are able to instantaneously turn off the live port and activate the target port. “Dual hot” configurations are also susceptible to complete failure if the error causing the failure is caused by the input to the servers (as both will fail simultaneously). Finally, in a larger installation comprising many servers the “dual hot” solution may be impractical due to cost and space considerations.

It is noted that the delay times given hereinabove are approximates and may vary from system to system.

### SUMMARY OF THE INVENTION

The present invention, in preferred embodiments thereof, seeks to provide an improved transport stream migration system and method. The invention enables migration of transport streams from one Internet protocol-television (IPTV) delivery server to another at a point in the transport stream that would result in generally no loss of service. The server may be responsible for decrypting the transport stream if the transport stream is already encrypted. The server may be responsible for encrypting the transport stream before delivering it. When the content provider decides to move a transport stream from one server to another, the two servers may negotiate for a suitable synchronization point. Once a suitable synchronization point is found, the servers may initiate a switch with reference to the negotiated synchronization point. Assuming that the latency for each server is generally the same, there may be no glitch on a set-top box viewing the channel. The movement of a transport stream between servers may allow maintenance and upgrades without interrupting the services currently streaming. Excluding complete instantaneous failure of a server, a group of IPTV delivery servers, operative in accordance with a preferred embodiment of the present invention, may provide generally 100 percent service up time. In a further preferred embodiment of the present invention, individual channels within a transport stream may be moved between servers.

There is thus provided in accordance with a preferred embodiment of the present invention, a transport stream migration method. The transport stream migration method includes providing a live server and a target server, the live server receiving a transport stream, designating exactly one of the live server and the target server as a controlling server, the controlling server receiving a migration instruction, the target server receiving a copy of the transport stream, negotiating a synchronization point by the live server and the target server, and migrating output of the transport stream from the live server to the target server with respect to a time determined from the synchronization point negotiated.

Additionally, in accordance with a preferred embodiment of the present invention, the method further includes initializing a conditional access system on the target server to decrypt and/or encrypt transport streams, and updating conditional access parameters of the target server with conditional access parameters received from the live server.

Furthermore, in accordance with a preferred embodiment of the present invention, the negotiating further includes searching by the live server and the target server for suitable reference point values, only if the live server is designated as the controlling server then designating the target server as the responding server, only if the target server is designated as the controlling server then designating the live server as the responding server, the responding server sending at least one proposed reference point value to the controlling server from among the suitable reference point values, the controlling server informing the responding server of a chosen synchronization point chosen from among the at least one proposed reference point values, and assigning the chosen synchronization point as the synchronization point.

Still further, in accordance with a preferred embodiment of the present invention, each of the at least one proposed reference point value includes one of the following, a program clock reference (PCR) and a presentation timestamp (PTS).

Moreover, in accordance with a preferred embodiment of the present invention, the method includes the live server and the target server applying timestamps to each transport stream packet received based on the incoming transport bitrate.

Additionally, in accordance a preferred embodiment of the present invention further includes determining a swap time by the controlling server, sending a swap delta calculated from the swap time and the synchronization point from the controlling server to the responding server, determining a swap time by the responding server from the received swap delta and the synchronization point, the live server finding a first splice point and sending a splice delta to the target server computed from the splice point and the synchronization point, and the target server computing a second splice point from the received splice delta and the synchronization point.

Moreover, in accordance with a preferred embodiment of the present invention, wherein the live server includes a first output buffer and the target server includes a second output buffer, and the migrating further includes the target server starting to fill the second output buffer from the second splice point, and the live server stopping filling the first output buffer at the splice point, thus allowing the output buffer of the live server to drain.

Furthermore, in accordance with a preferred embodiment of the present invention, wherein the transport stream is an MPEG-2 compliant transport stream and wherein the method further includes managing control word polarity.

Still further, in accordance with a preferred embodiment of the present invention, wherein the migrating is of at least one transport stream, and the live server generates at least two transport streams from a single transport stream received.

There is thus further provided in accordance with another preferred embodiment of the present invention, a transport stream migration system. The transport stream migration system includes at least one live server to deliver a received transport stream, at least one target server to take over delivery of a transport stream received by the at least one live server, a transport stream splitter and switch unit to copy the received transport stream and control the delivery of the transport stream to the at least one live server and the at least one target server, an Internet protocol (IP) switch to direct the output of the at least one live server and the at least one target server, and a control unit to schedule a migration from the at least one live server to the at least one target server.

Additionally, in accordance with a preferred embodiment of the present invention, the transport stream splitter and switch unit includes at least one of the following, at least one IP switch, at least one asynchronous serial interface (ASI) splitter and at least one ASI switch, and at least one ASI matrix.

Furthermore, in accordance with a preferred embodiment of the present invention, wherein the received transport stream is a MPEG-2 transport stream.

Moreover, in accordance with a preferred embodiment of the present invention, wherein the migration from the at least one live server to the at least one target server begins with a first transport packet of a UDP/IP datagram.

There is thus further provided in accordance with another preferred embodiment of the present invention, a transport stream migration method including at least one live server receiving a transport stream, scheduling a migration from the at least one live server to at least one target server, copying the received transport stream and controlling the delivery of the transport stream and transport stream copy to the at least one live server and at the least one target server by a transport stream splitter and switch unit, and directing the output of the at least one live server and the at least one target server by an IP switch.

Additionally, in accordance with a preferred embodiment of the present invention, the transport stream splitter and switch unit includes at least one of the following, at least one IP switch, at least one asynchronous serial interface (ASI) splitter and at least one ASI switch, and at least one ASI matrix.

Furthermore, in accordance with a preferred embodiment of the present invention, the received transport stream is a MPEG-2 transport stream.

Moreover, in accordance with a preferred embodiment of the present invention, the migration from the at least one live server to the at least one target server begins with a first transport packet of a UDP/IP datagram.

There is thus further provided in accordance with another preferred embodiment of the present invention, a transport stream migration system. The transport stream migration system includes a live server receiving a transport stream, a target server receiving a copy of the transport stream, wherein exactly one of the live server and the target server is designated as a controlling server, a control unit to issue a migration instruction to the controlling server, a negotiator on the live server and the target server to control negotiation of a synchronization point between the live server and the target server, and a migration controller on the live server and the target server to migrate output of the transport stream from the live server to the target server with respect to a time determined from the synchronization point negotiated.

Additionally, in accordance with a preferred embodiment of the present invention, the system further includes a conditional access system on the target server to decrypt and/or encrypt transport streams with updated conditional access parameters received from the live server.

Furthermore, in accordance with a preferred embodiment of the present invention, the negotiator includes a search unit to look for suitable reference point values, a responding server wherein, only if the live server is designated as the controlling server, the target server is designated as the responding server, and only if the target server is designated as the controlling server, the live server is designated as the responding server, a communication unit on the responding server to send at least one proposed reference point value to the controlling server from among the suitable reference point values, and a receiver on the target server to receive a chosen synchronization point chosen by the controlling server from among the at least one proposed reference point values.

Still further, in accordance with a preferred embodiment of the present invention; each of the at least one proposed reference point value includes one of the following, a program clock reference (PCR) and a presentation timestamp (PTS).

Moreover, in accordance with a preferred embodiment of the present invention, the live server and the target server apply timestamps applied to each transport stream packet received based on the incoming transport bitrate.

Additionally, a preferred embodiment of the present invention, wherein, the controlling server determines a first swap time, the controlling server calculates a swap delta from the swap time and the synchronization point and sends the swap delta to the responding server, the responding server computes a second swap time from the swap delta and the synchronization point, the live server computes a splice delta from a first splice point and the synchronization point, and the target server computes a second splice point from the splice delta and the synchronization point.

Furthermore, in accordance with a preferred embodiment of the present invention, the live server includes a first output buffer and the live server stops filling the first output buffer from the first splice point and the target server includes a second output buffer and the target server starts to fill the second output buffer from the second splice point.

Moreover, in accordance with a preferred embodiment of the present invention, the transport stream includes an MPEG-2 compliant transport stream and the system further includes a control word polarity manager.

Still further, in accordance with a preferred embodiment of the present invention, the migration controller controls the migration of at least one transport stream wherein the live server generates at least two transport streams from the single transport stream received.

### BRIEF DESCRIPTION OF THE DRAWINGS

The present invention will be understood and appreciated more fully from the following detailed description, taken in conjunction with the drawings in which:

FIG. 1 is a partially pictorial, partially block diagram illustration of an IPTV delivery system, operative in accordance with a preferred embodiment of the present invention;

FIGS. 2 and 3 are data flow illustrations of an IPTV transport stream migration system, which is comprised of a portion of the IPTV delivery system of FIG. 1, operative in accordance with preferred embodiments of the present invention, wherein in FIGS. 2A-C a transport stream input is received by at least one splitter-switch unit and in FIGS. 3A-C a transport stream input is received by an IP switch;

FIGS. 4A-D are simplified flow chart diagrams of a transport stream migration method, operative in accordance with a preferred embodiment of the present invention;

FIG. 5A is a conceptual illustration of exemplary transport streams and packetization, useful in understanding the present invention; and

FIG. 5B is a conceptual illustration of the transport stream migration method, operative in accordance with a preferred embodiment of the present invention.

It is noted that for simplicity and clarity of illustration, elements shown in the figures have not necessarily been drawn to scale. Further, where considered appropriate, reference numerals may be repeated among the figures to indicate corresponding or analogous elements.

### DETAILED DESCRIPTION OF A PREFERRED EMBODIMENT

The present invention, in preferred embodiments thereof, seeks to provide an apparatus and methods for transport stream migration from one Internet protocol-television (IPTV) delivery server to another at a point in the transport stream that would result in generally no loss of service. The server may be responsible for decrypting the transport stream if the transport stream is already encrypted. The server may be responsible for encrypting the transport stream before delivering it. When the content provider decides to move a transport stream from one server to another, the two servers may negotiate for a suitable synchronization point. Once a suitable synchronization point is found, the servers may initiate a switch with reference to the negotiated synchronization point. Assuming that the latency for each server is generally the same, there may be no glitch on a set-top box viewing the channel. The movement of a transport stream between servers may allow maintenance and upgrades without interrupting the services currently streaming. Excluding complete instantaneous failure of a server, a group of IPTV delivery servers, operative in accordance with a preferred embodiment of the present invention, may provide generally 100 percent service up time. In a further preferred embodiment of the present invention, individual channels within a transport stream may be moved between servers.

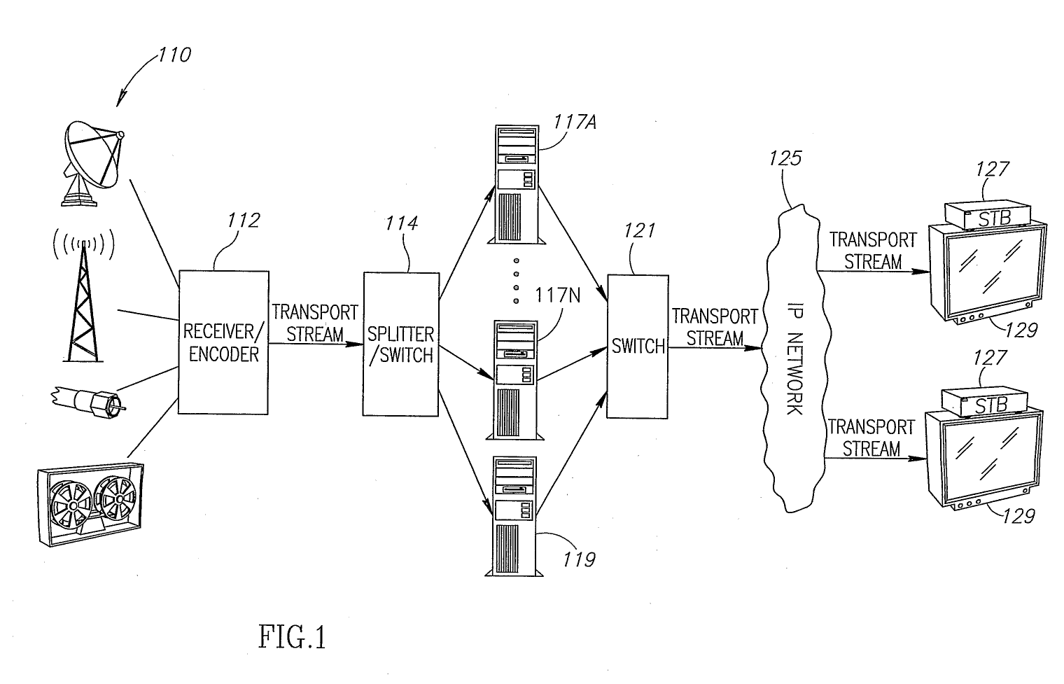

Reference is now made to FIG. 1, which is a partially pictorial, partially block diagram illustration of an IPTV delivery system, operative in accordance with a preferred embodiment of the present invention. Television content may be delivered via an appropriate network 110, for example, satellite, wireless, or wired, or sent from recorded media. The content may be received by an appropriate receiver/encoder 112 known in the art. The content may be converted to conform to a known appropriate transport stream protocol and delivered to an appropriate splitter/switch 114 known in the art. At least one live delivery server 117 A-N (herein live servers 117) may perform real-time decryption of a particular service(s) within the incoming transport stream. Live servers 117 may also perform real-time encryption of a particular service(s) within the incoming transport stream. Entitlement control messages (ECMs), which may contain the conditional access (CA) criteria, may be delivered with the encrypted service either as a separate data stream or inside the transport stream. In the discussion hereinbelow, the term transport stream refers to both the content stream and the ECM stream if an ECM stream is present. Live servers 117 may also pace the content smoothly onto the network even if the incoming transport stream is bursty.

Live servers 117 may further IP encapsulate the transport streams, for example, as a user datagram protocol (UDP) multicast and may route them via an appropriate switch 121 known in the art. The transport streams may be sent directly across the backbone distribution IP network 125 to appropriate set-top boxes 127 for display on televisions 129. In addition to live servers 117, the IPTV delivery system may comprise between one and M additional delivery server(s), herein termed target server(s) 119, which may be used in a redundant transport stream migration method, operative in accordance with a preferred embodiment of the present invention. For clarity purposes only, a single target server 119 is shown in FIG. 1. Live servers 117 and target server(s) 119 may be generally equivalent physically. However, live servers 117 are generally used for delivery whereas target server(s) 119 may be used as a temporary replacement for a given live server 117. Alternatively, in a preferred embodiment of the present invention, individual transport streams may be moved from one live server to another live server (for example for load balancing purposes). Hence, the migrating may be of at least one transport stream from among the at least two transport streams being generated by live server 117 from the single transport stream received. When transport streams are moved between live servers, the live server taking over the delivery responsibility is considered herein the target server. A target server 119, operative in accordance with the present invention, may be used to schedule a transport stream migration with generally no loss of service. For scalability purposes a target server solution that uses N+M servers where N>M is preferable.

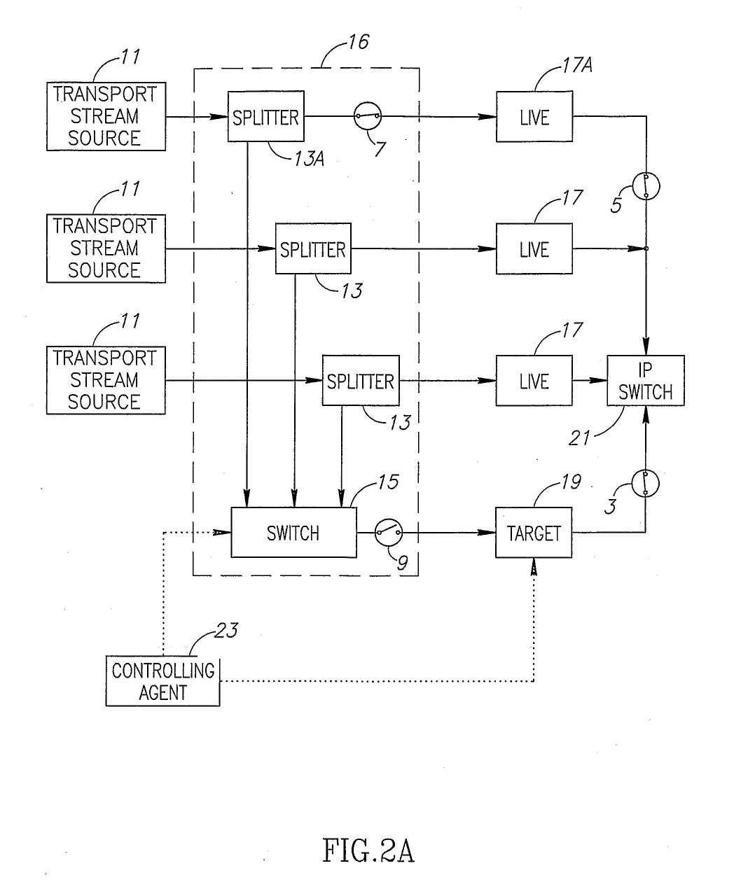

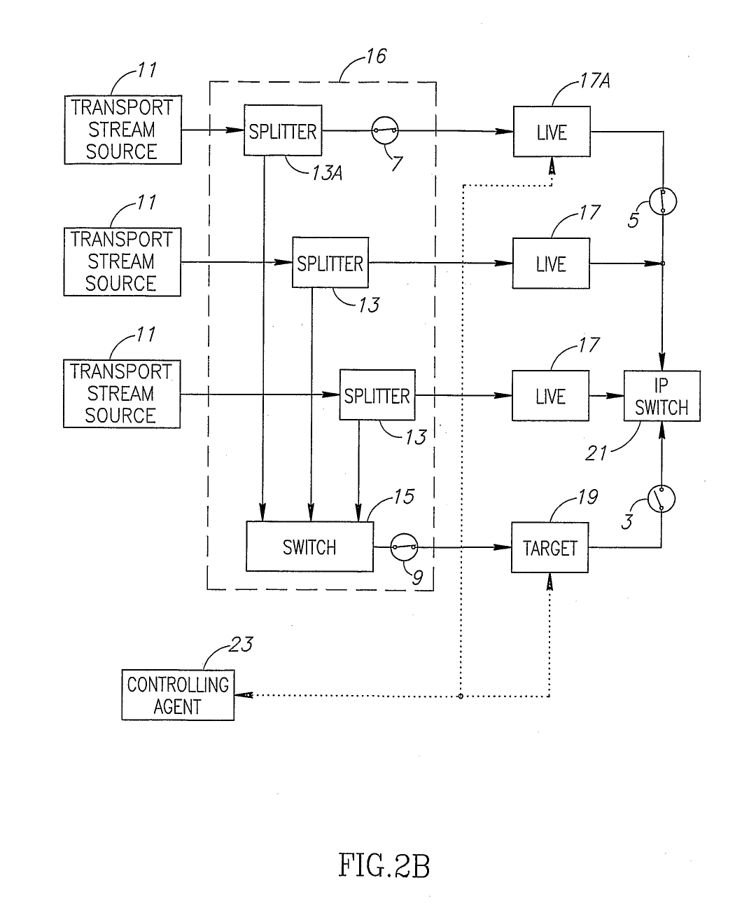

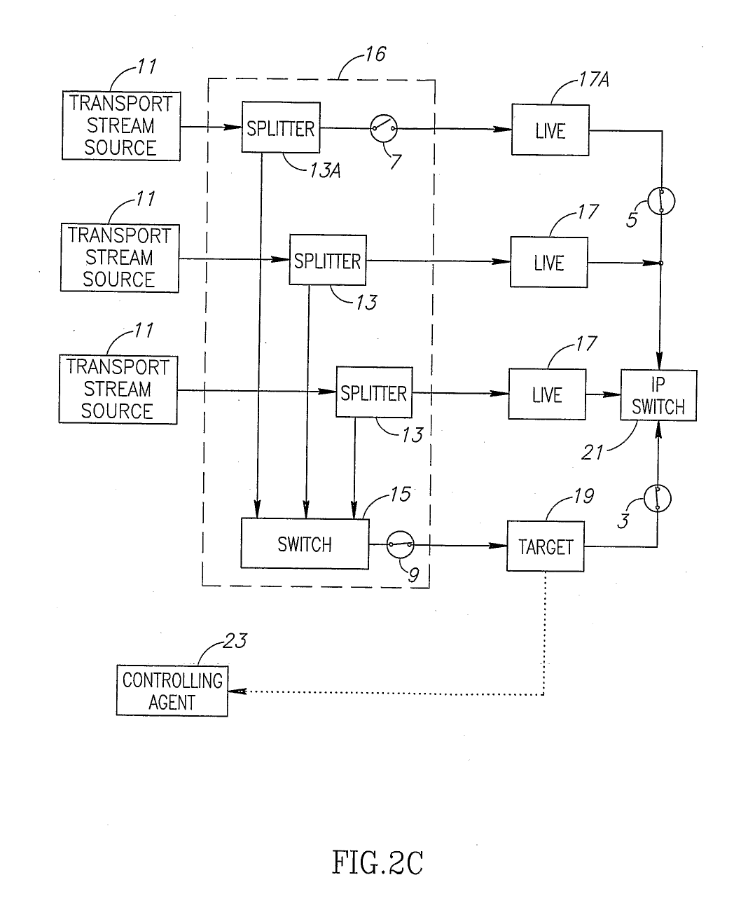

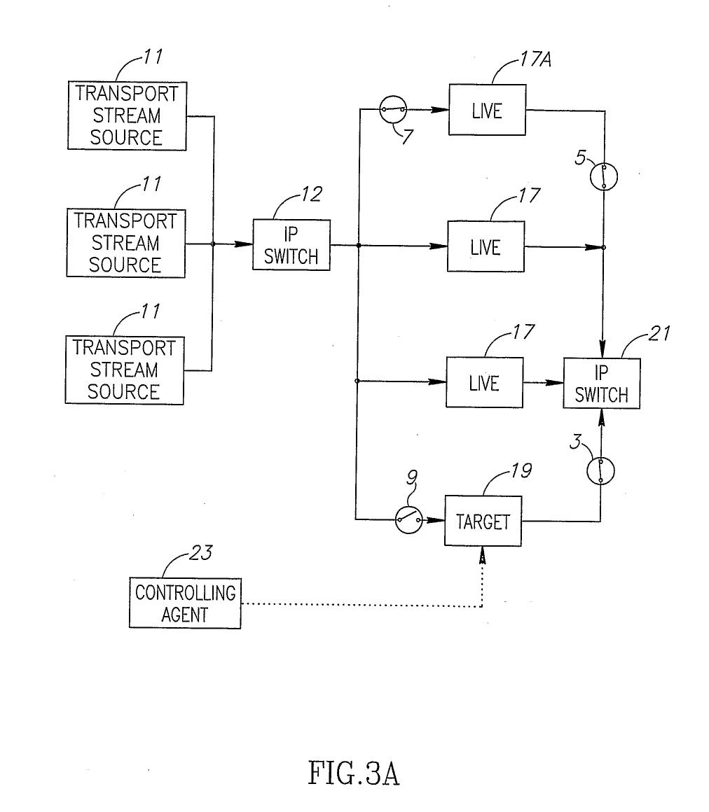

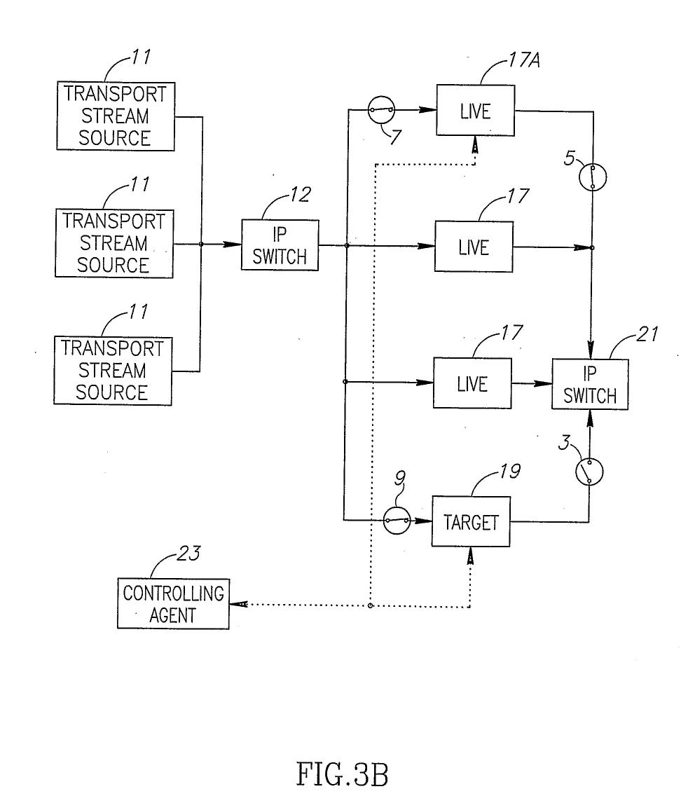

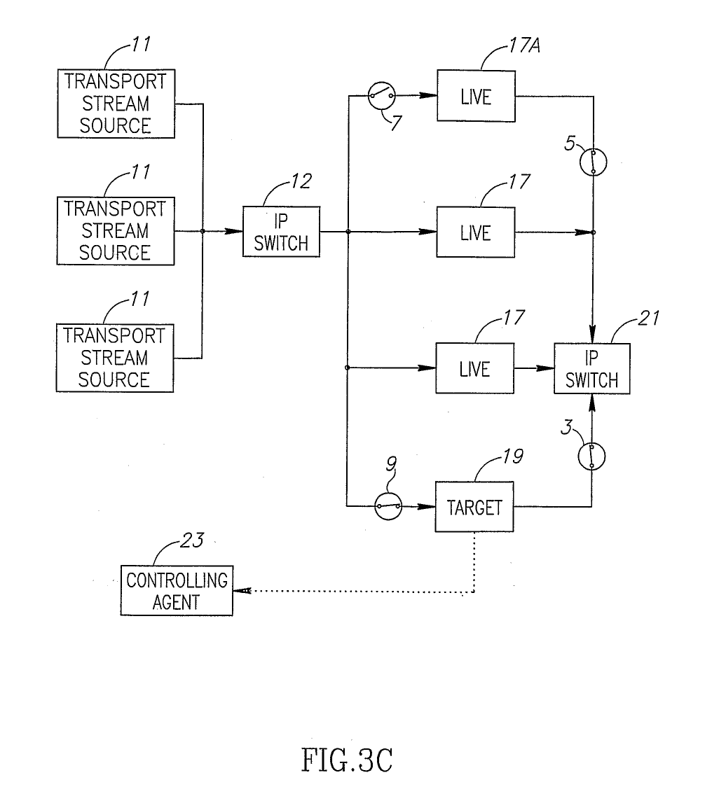

Reference is now made to FIGS. 2A-C and 3A-C, which are illustrations of data flow in an IPTV transport stream migration system, which is comprised of a portion of the IPTV delivery system of FIG. 1, operative in accordance with preferred embodiments of the present invention. In FIG. 2 transport stream input is received by at least one splitter-switch unit. In FIG. 3 transport stream input is received by an IP switch and the transport streams are carried by a protocol that can be routed to and replicated between ports on that switch, by that switch (e.g. UDP multicast). Splitter-switch unit 16 and IP switch 12 are detailed illustrations of splitter/switch 114 of FIG. 1. Live server(s) 17 are generally equivalent to live server(s) 117 of FIG. 1. Target server(s) 19 are generally equivalent to target server(s) 119 of FIG. 1. For clarity purposes only, in the description of FIGS. 2 and 3, target server(s) 19 is the controlling server as noted hereinbelow. IP switch 21 is generally equivalent to switch 121 of FIG. 1.

Elements with the same reference numerals in FIGS. 2A-C and 3A-C are generally equivalent. IP switches 12 and 21 may be any appropriate networking switches known in the art. A networking switch routes IP traffic to the output port associated with an attached device(s) that requested the IP traffic. Controlling agent 23 may comprise a graphical user interface and/or may be an automated system. Conceptual on/off switches (herein conceptual switches) 3, 5, 7, and 9 are used to indicate whether data may flow on the network. A closed switch indicates that data may flow. An open switch indicates that data may not flow. In preferred embodiments of the present invention, live server(s) 17 and target server(s) 19 may comprise any server(s) appropriate for use in an IPTV transport stream migration system, wherein the server(s) may maintain an internal timestamp that may be used to synchronize different server machines. An example of an appropriate server is the StreamShaper™ product (commercially available from NDS Limited).

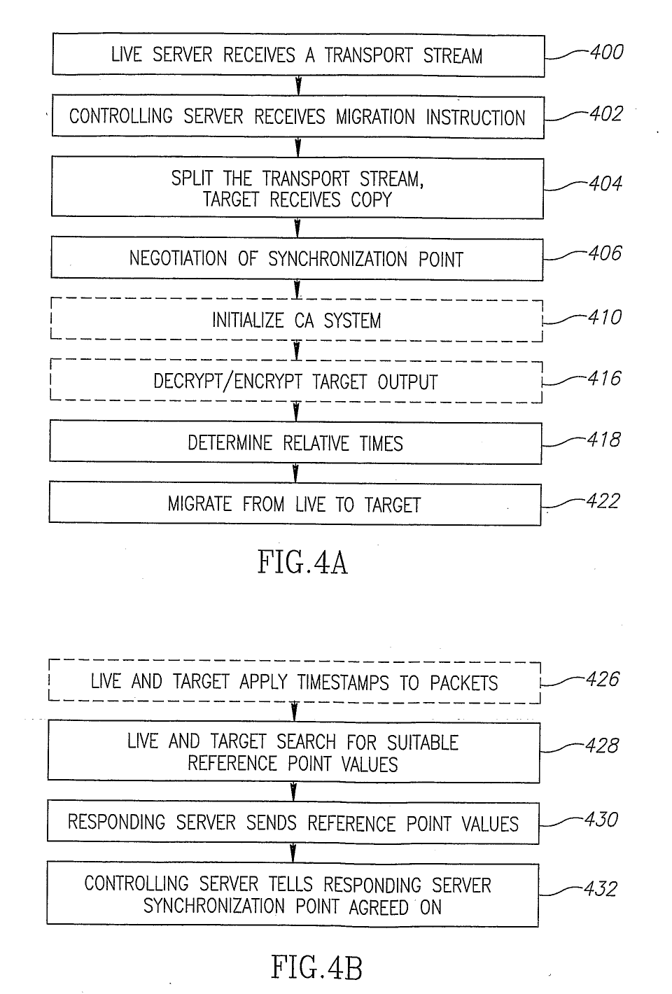

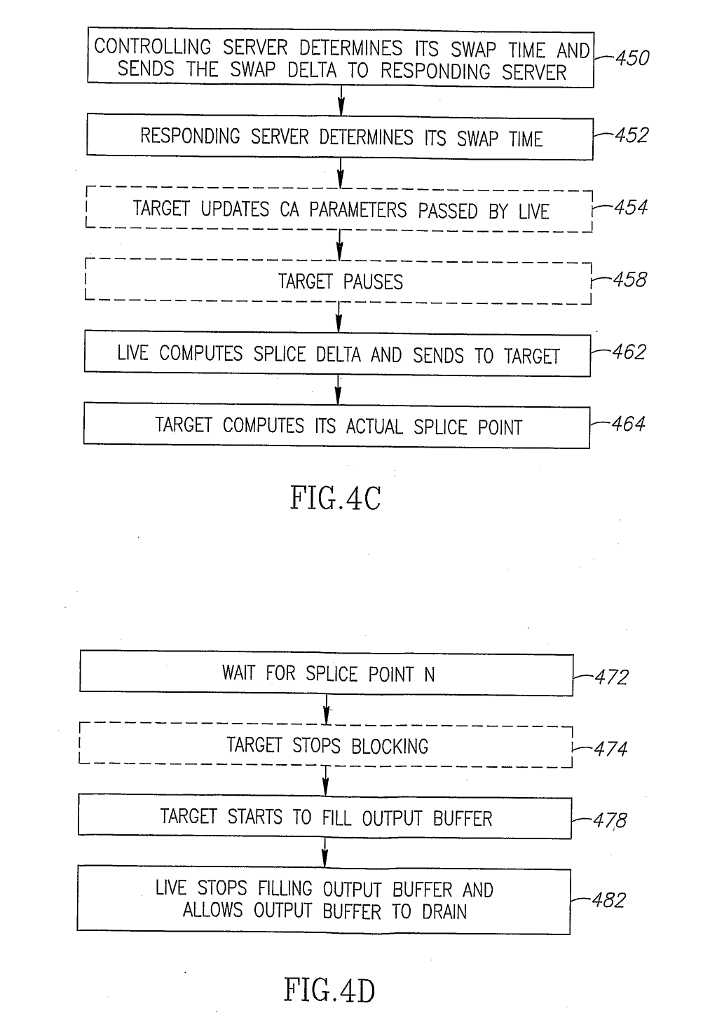

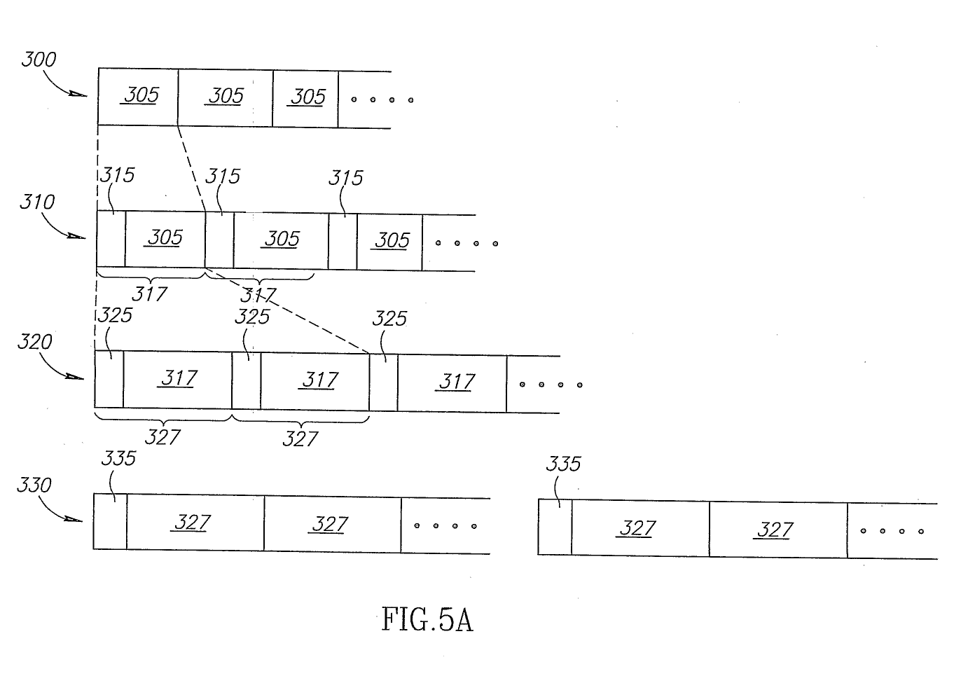

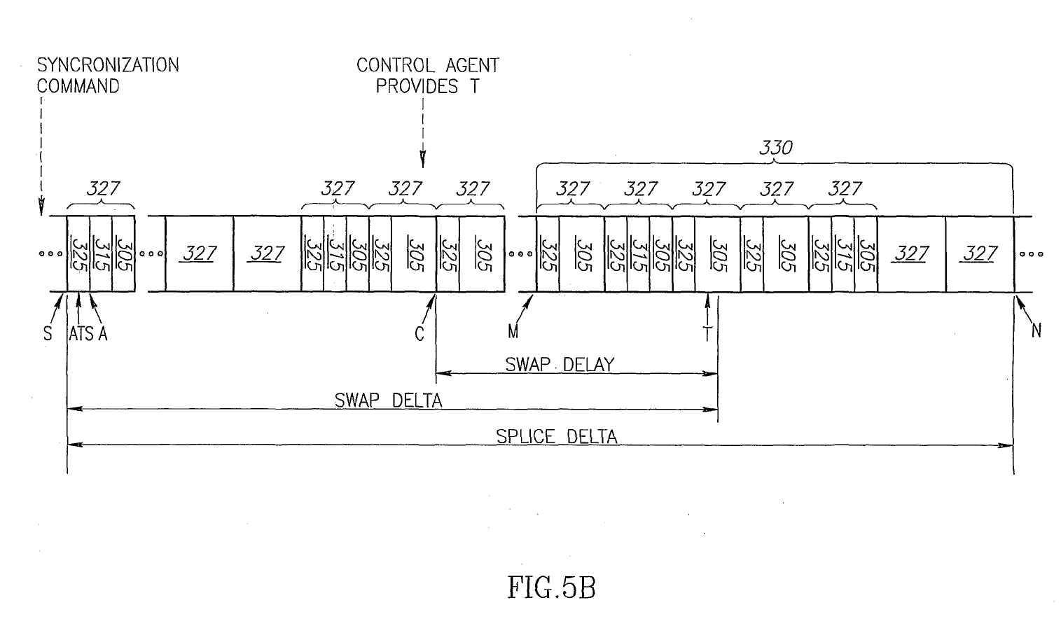

In preferred embodiments of the present invention, transport stream source 11 may send transport stream packets. An appropriate transport stream comprises a regular generally unique time stamp. For example, an MPEG-2 transport packet contains a program clock reference (PCR) that may be used as described hereinbelow with respect to FIGS. 4 and 5. Hence, a server(s) in a preferred embodiment of the present invention may have two different types of timestamps, one a part of the data stream and another internal to the server(s).

Referring specifically to FIGS. 2A-C, in a preferred embodiment, the IPTV transport stream migration system may comprise a splitter-switch unit 16, at least one live server 17, at least one target server 19, an IP switch 21, conceptual switches 3, 5, 7, and 9, and a controlling agent 23. Splitter-switch unit 16 may comprise at least one splitter 13 and a switch 15 in a preferred embodiment of the present invention, wherein the number of splitters 13 may equal the number of live servers 17. In an alternative preferred embodiment, splitter-switch unit 16 may be implemented as a single matrix, for example, as an asynchronous serial interface (ASI) matrix. At least one splitter 13 and switch 15 may be any appropriate splitter and switch known in the art, for example, an ASI splitter and an ASI switch. It is noted that for clarity in FIG. 2 and the related discussion hereinbelow, one switch 15, splitter-switch unit 16, IP switch 21, and target server 19 are shown; however, other configurations using more than one of any of these elements may occur to a person skilled in the art and are within the scope of the present invention. It is further noted that for clarity in FIG. 2 and the related discussion hereinbelow, reference is only made to splitter 13A and live server 17A and conceptual switches are not shown with regard to other splitters 13 and/or live servers 17.

FIGS. 2A-C illustrate the general data flow in an IPTV transport stream migration system during a transport stream migration. Details of a transport stream migration method are described in detail hereinbelow with respect to FIGS. 4 and 5. The initial data flow is shown in FIG. 2A. At least one transport stream source 11 may send transport stream packets to splitter(s) 13. Splitter 13 may split the transport stream, and may send one copy to a live server 17 and another copy to switch 15. Conceptual switch 7 is shown as closed, indicating that the transport stream may reach a live server 17A. Switch 15 may receive all the live transport stream data and may drop all the data or may route one transport steam as output to a target server 19. Target server 19 may receive a data stream only when preparing for or at the splice point of a transport stream migration; hence conceptual switch 9 is open indicating that data may be prevented from reaching target server 19. IP switch 21 may receive the transport stream output of any of live server(s) 17, specifically from live server 17A as shown by closed conceptual switch 5. It is noted that the output of any live server 17 or target server 19 may be empty. As any output of target 19 must be empty at this point, conceptual switch 3 may be closed (as shown) or open.

Controlling agent 23 may control transport stream migrations. Controlling agent 23 may instruct switch 15 to perform a transport stream migration from live server 17A to target server 19. Controlling agent 23 may instruct switch 15 as to which input may be routed to its output, thus controlling which transport stream may be sent to target machine 19. Initiation of a transport stream migration may entail communication from controlling agent 23 to switch 15 and target server 19 as shown by the dotted arrows (assuming target server 19 is the controlling server).

FIG. 2B illustrates the data flow during the negotiation and preparation of the transport stream migration from live server 17A to target server 19. Switch 15 may receive input from splitter 13A and may output data to target server 19, as indicated by closed conceptual switch 9. Splitter 13A may also send output to live server 17A as indicated by closed conceptual switch 7. During the negotiation and preparation phases, IP switch 21 may receive the output of live server 17A as indicated by closed conceptual switch 5. However, the output of target 19 may be discarded and not sent to IP switch 21 as indicated by open conceptual switch 3. Live server 17A and target server 19 may communicate directly during the negotiation phase in a preferred embodiment of the present invention. Controlling agent 23, in a further preferred embodiment of the present invention, may control communications between live server(s) 17 and target server 19. Hence, controlling agent 23 may be involved in transport stream migration negotiations between live server 17 and target server 19 or controlling agent 23 may only monitor the negotiations. The possible communications paths are shown by the dotted arrows.

FIG. 2C illustrates the data flow from the splice point of the of the transport stream migration, i.e. after the migration from live server 17A to target server 19. Once migration to target server 19 has concluded output of splitter 13A may not reach live server 17A as shown by open conceptual switch 7. The output buffer of live server 17A will have drained and hence the output of live server 17A will be empty, hence, conceptual switch 5 may be closed (as shown) or open. From the splice point on, data continues to flow from switch 15 “through” conceptual switch 9 to target server 19. All new data from target server 19 may now be received by IP switch 21 as shown by closed conceptual switch 3. Target server 19 may inform controlling agent 23 that the migration is complete as shown by the dotted arrow (assuming target server 19 is the controlling server).

Referring back to FIGS. 3A-C, the IPTV transport stream migration system may comprise an IP switch 12, at least one live server 17, at least one target server 19, an IP switch 21, conceptual switches 3, 5, 7, and 9, and a controlling agent 23, operative in accordance with a preferred embodiment of the present invention. It is noted that for clarity in FIG. 3 and the related discussion hereinbelow, reference is only made to live server 17A and conceptual switches are not shown with regard to other live servers 17. It is further noted that for clarity in FIG. 3 and discussion hereinbelow, one IP switch 12, one target server 19, and one IP switch 21 are shown; however, other configurations using more than one of any of these elements may occur to a person skilled in the art and are within the scope of the present invention.

FIGS. 3A-C illustrates the general data flow in an IPTV transport stream migration system during a transport stream migration. Details of a transport stream migration are described in detail hereinbelow with respect to FIGS. 4 and 5. The initial data flow is shown in FIG. 3A. At least one transport stream source(s) 11 may send transport stream packets to IP switch 12. IP switch 12 may replicate the transmission stream and may control which transport stream, if any, is received by live server(s) 17 and target server(s) 19. IP switch 12 may send IP transport streams to any of live server(s) 17 and target machine(s) 19. Conceptual switch 7 is shown as closed, indicating that a transport stream may reach live server 17A. Target server 19 may receive a data stream only when preparing for or at the splice point of a transport stream migration; hence conceptual switch 9 is open indicating that data may be prevented from reaching target server 19. IP switch 21 may receive the transport stream output of any of live server(s) 17, specifically from live server 17A as shown by closed conceptual switch 5. It is noted that the output of any live server 17 or target server 19 may be empty. As any output of target 19 must be empty at this point, conceptual switch 3 may be closed (as shown) or open.

Controlling agent 23 may control transport stream migrations. Initiation of a transport stream migration may entail communication from controlling agent 23 to target server 19 as shown by the dotted arrow (assuming target server 19 is the controlling server). Controlling agent 23 may instruct target server 19 to perform a transport stream migration from live server 17A to target server 19. Controlling agent 23 need not communicate with IP switch 12, as IP switch 12 may be able to route the correct IP encapsulated streams automatically to live server 17 and target servers 19.

FIG. 3B illustrates the data flow during the negotiation and preparation of the transport stream migration from live server 17A to target server 19. IP switch 12 may output data to target server 19, as indicated by closed conceptual switch 9. IP switch 12 may also send output to live server 17A as indicated by closed conceptual switch 7. During the negotiation and preparation phases, IP switch 21 may receive the output of live server 17A as indicated by closed conceptual switch 5. However, the output of target 19 may be discarded and not sent to IP switch 21 as indicated by open conceptual switch 3. Live server 17A and target 19 may communicate directly during the negotiation phase in a preferred embodiment of the present invention. Controlling agent 23, in a further preferred embodiment of the present invention, may control communications between live server(s) 17 and target server 19. Hence, controlling agent 23 may be involved in transport stream migration negotiations between live server 17 and target server 19 or controlling agent 23 may only monitor the negotiations. The possible communications paths are indicated by the dotted arrows.

FIG. 3C illustrates the data flow from the splice point of the of the transport stream migration, i.e. after the migration from live server 17A to target server 19. Once migration to target server 19 has concluded output of IP switch 12 may not reach live server 17A as shown by open conceptual switch 7. The output buffer of live server 17A will have drained and hence the output of live server 17A will be empty, hence, conceptual switch 5 may be closed (as shown) or open. From the splice point on, data continues to flow from IP switch 12 “through” conceptual switch 9 to target 19. All new data from target server 19 may now be received by IP switch 21 as shown by closed conceptual switch 3. Target server 19 may inform controlling agent 23 that the migration is complete as shown by the dotted arrow (assuming target server 19 is the controlling server).

In the discussion hereinabove with respect to FIGS. 2A, 2C, 3A, and 3C, the possible communication is shown as being between controlling agent 23 and target server 19. This communication may be, for example, an instruction to perform a transport stream migration or that a transport stream migration has been completed. In the case of communication between controlling agent 23 and target server 19, target server 19 may be designated the controlling server. It is noted that communication may be between controlling agent 23 and alive server 17 (not shown for clarity purposes), for example, live server 17A wherein the live server 17 is the controlling server. Embodiments wherein a live server 17 is the controlling server are within the scope of the present invention.

In the redundant architecture of FIGS. 2 and 3, configuration files may be automatically copied from live server(s) 17 to target server 19. When the configuration of any live server 17 is changed, an update may be automatically made to the configuration file and the configuration file may be copied again to target server 19. Hence, target server 19 may generally immediately take up the configuration of any live server 17 to effect a transport stream migration. Alternatively, when one of live servers 17 is to be taken offline, its configuration may be sent to target server 19.

Well known standards exist for transport streams and packetization in the current art. Reference is now made to FIG. 5A, a conceptual illustration of exemplary transport streams and packetization, useful in understanding the present invention. A single TV channel is built out of a number of elementary streams (e.g. video, audio etc.). An elementary stream 300 may comprise variable length, logical units of content 305. Logical units of content 305 may comprise, for example, video frames, audio frames, pages of subtitles, or other appropriate content. Content 300 may be transformed into a packetized elementary stream (PES) 310 by appending a variable length PES header 315 before each logical unit of content 305, creating variable length packets 317. PES header 315 may include a presentation timestamp (PTS) that determines the time at which the contents of the PES that follows may be presented to a user.

PES 310 may be converted into an MPEG-2 transport stream 320, wherein transport stream packet headers 325 are inserted at regular intervals within PES 310 dividing each packet 317 into at least one MPEG-2 transport packet 327. The MPEG-2 transport stream packet header may comprise a predetermined number of bytes, for example, 4, and may include an identifier for the individual PES packet 317 associated with it. A single PES packet 317 may now be spread over several MPEG-2 packets 327. Transport stream packet headers 325 may further comprise a sample of the program clock reference (PCR) via an optional adaptation field. Each sample may be used to calculate the bitrate of the transport stream or to interpolate a timestamp per transport stream packet. MPEG-2 transport packets are generally of a fixed length, which may enable receivers to parse the transport stream easily. An MPEG-2 transport stream may further allow different elementary streams to be interleaved.

For an IP network, transport stream 320 may be divided into a multiplicity of packets encapsulated with internet protocol (IP). For IPTV, these packets may be user datagram protocol/internet protocol (UDP/IP) datagrams 330. A UDP/IP header 335 is added to each UDP/IP datagram, which typically comprises a fixed number of MPEG-2 packets, for example, 7. A logical unit of content 305 may be split between different UDP/IP packets.

Reference is now made to FIG. 4A, a simplified flow chart diagram of a preferred method of transport stream migration, operative in accordance with a preferred embodiment of the present invention. In the discussion hereinbelow, for clarity of the description, a single live server and target server are used. It is noted however, that multiple live servers and target servers are possible in various configurations and are within the scope of the present invention. In the discussion hereinbelow, either the live server or the target server may control the migration negotiations. Hence, the term controlling server and responding server will be used in the discussion hereinbelow when appropriate. Additionally, once synchronization has completed, the controlling agent may treat the controlling server from the synchronization method as the responding server and may treat the responding server from the synchronization method as the controlling server to perform the swap itself.

The live server receives a transport stream (400). Controlling agent 23 of FIGS. 2 and 3 may request and/or schedule a controlling server to migrate a transport stream to a target server at time T in the future (402). The migration request may comprise a synchronization command and a time at which to perform the synchronization. As mentioned hereinabove, controlling agent 23 may be an automatic program and/or a user interface. A scheduled migration may allow, for example, a scheduled update of software and/or hardware, for antivirus software to execute, or migration may be performed upon predetermined conditions that may indicate an impending system failure before the failure occurs to provide uninterrupted delivery. The data stream may be split which may allow the target server and live server to receive the same data stream input (404).

The controlling server may begin synchronization negotiations with the responding server (406). As the live server and the target server may be receiving identical data, the reference point used in the synchronization may be taken from the transport steam data input. Therefore, by finding a suitable reference point in a single transport packet of the input, it may be possible for the two server machines to synchronize. A reference point may be considered suitable if the reference point may appear in only a single transport packet. Providing both machines are looking for the same kind of reference and the reference is suitable, anything suitable may be used. In a preferred embodiment of the present invention, the program clock reference (PCR) may be used as the reference point. The PCR may be included in an optional extension to the transport stream header. In a further preferred embodiment of the present invention, the PTS value in a PES header may be used as the reference point. Other suitable reference points may occur to those skilled in the art and are within the scope of the present invention. In the discussion hereinbelow, for clarity of the discussion, the PCR will be used as an exemplary non-Limiting reference point. The negotiation method is described in greater detail hereinbelow with respect to FIG. 4B.

The live and target servers may infer a timestamp, herein termed a server timestamp, for every packet that passes through the system. The server timestamps may be derived from the bitrate of the transport stream (e.g. the server timestamps may be derived from the PCR in the transport stream). In prior art IPTV delivery servers a server timestamp may be necessary to calculate the delivery time of the transport packet. When the negotiation method has completed both the live and target servers know which packet has been chosen as the synchronization point.

Optionally, the conditional access system (CA) of the target server may be initialized (410), for example, if a CA system is operating on the live server. The CA system of the target server may be activated with the same parameters as the CA system of the live server using the same CA stream. If the live server is encrypting and/or decrypting the transport streams, the live server may send its current encryption and/or decryption status to the target server so that the target server may use the same values. The sending of the current encryption and/or decryption status may be done before the swap occurs such that at the point of swap the encryption and/or decryption status is identical on the live and target servers. The current parameters may be sent from the live server to the target server during the determination of the swap point. Alternatively, each change in encryption and/or decryption status may be sent from the live server to the target server in the period between the synchronization and the swap. In a further alternative, the live server may send the CA parameters after synchronization (before determining relative times) and may stop processing CA updates for that transport stream until the swap has finished. The choice of implementation may depend on how quickly the encryption and/or decryption parameters may be applied on the target machine (i.e. they must be in place for all transport packets that follow the swap point).

Optionally, the CA system of the target server may decrypt and/or encrypt the data input and/or output as necessary (416). The server timestamps may optionally be used to control the encryption/decryption processes of the CA system (for example, the timing of control word changes). For example, if the data stream the target server receives is encrypted the data stream may be 1) delivered unchanged, 2) decrypted and delivered, or 3) decrypted, encrypted with new parameters, and then delivered. For example, if the data stream the target server receives is not encrypted the data stream may be 1) delivered unchanged or 2) encrypted and then delivered. When encrypting, the target server may use the CA parameters to ensure that the next change of control word is “clean”. For example, an MPEG-2 transport stream is marked as encrypted using two polarities (odd and even), both meaning the same thing (encrypted); however, a transition from one polarity to the other indicates that the control word has changed. When the target server receives its first control word from the CA system the target server must maintain the correct polarity to use the correct control word to be considered “clean”. This change of control word may constitute an extra step either before or after the swap itself.

Once a synchronization point has been agreed upon, the swap may be set up at some point in the future with respect to the server timestamps of the live and target servers. After synchronization, each server may have a pair of values comprising the agreed upon reference point and the server timestamp of the transport packet containing that reference point. Relative times may be determined for specific transport packets by the live server and target server (418) from each server's pair of values as they provide a common point of reference in the transport stream. The determination of relative time method is described in greater detail hereinbelow with respect to FIG. 4C. The transport stream received by IP switch 21 (FIGS. 2 and 3) may be migrated from the output of the live server to the output of the target server (422). The migration method is described in greater detail hereinbelow with respect to FIG. 4D.

Reference is now made to FIG. 4B, a simplified flow chart diagram of a preferred synchronization point negotiation method, operative in accordance with a preferred embodiment of the present invention. Optionally, as mentioned hereinabove, the live server and the target server may generate and apply server timestamps to each transport stream packet they output (426). The server timestamps may be stored and referenced; they need not be inserted into the output bitstream. The timestamps on the live and target server may have the same resolution so that no time conversion is required in communications between the two servers. Additionally, the timestamps may have the same resolution as the PCR (for example, 27 MHz) so that no time conversion is required. As PCR samples need not be included in every transport packet, it may be necessary to interpolate the value(s) for each packet between each sample (assuming a constant bitrate between two samples).

Both the live server and target server may search for suitable reference point values in the data stream input (428). As mentioned hereinabove, both the live server and the target server may be receiving identical transport stream data. The responding server sends the controlling server at least one proposed reference point value from among the suitable reference point values as possible synchronization points (430). When a match of a reference point is made, the controlling server may send a message to the responding server indicating the particular reference point to use as the synchronization point (432). The controlling server may thus inform the responding server of the chosen synchronization point chosen from among the at least one proposed reference point values and both servers may assign the chosen synchronization point as the synchronization point.

Reference is now made to FIGS. 5B, 4C, and 4D, a non-limiting exemplary preferred embodiment of a portion of transport stream migration using the program clock reference (PCR) in a transport packet of an MPEG-2 data stream, in accordance with a preferred embodiment of the present invention. FIG. 5B is a conceptual illustration of the transport stream migration method. FIG. 4C is a simplified flow chart diagram comprising further details of determining relative times (418) of FIG. 4A. FIG. 4D is a simplified flow chart diagram comprising further details of migrating from the live server to the target server (422) of FIG. 4A.

As mentioned hereinabove, a synchronization command may have been provided by the controlling agent as part of the migration instruction (FIG. 4A 402) as shown by the arrow “synchronization command” in FIG. 5B. A represents the suitable reference point value, for example, a PCR agreed upon by the live and target servers as the synchronization point. S is the transport stream packet that contains A. ATS is the server timestamp (assigned by each server to its data stream output) for the transport stream packet beginning at S. The ATS may also be referred to as the synchronization point.

As shown by the arrow “control agent provides T”, the control agent may have provided the time at which to perform the migration. C is the server timestamp of the first transport packet processed after the controlling agent provided the swap time.

M and N are the start points of two sequential datagrams 330. Datagram 330, which begins at M, may comprise seven transport stream packets 327. T may be the time that was designated by the controlling agent to begin migration of the transport stream to the target server. The notation TS used in the equations below indicates a server timestamp.

Time T may be given to the controlling server by the controlling agent in terms of any unit of time (for example, hours, minutes or seconds) but this may not be appropriate for the servers to use directly. Therefore, T may be converted to Tᵣₑₗₐₜᵢᵥₑ, a time relative to the receipt of T (if T is an absolute time and is received at time T_{receipt}, Tᵣₑₗₐₜᵢᵥₑ=T−T_{receipt} but if T is already a relative time, Tᵣₑₗₐₜᵢᵥₑ=T). In the exemplary embodiment of the present invention, T is then converted into the same units as the server timestamps. Other embodiments wherein the conversion may take place later are also within the scope of the present invention. This converted time is herein referred to as a “swap delay”. It may not be sufficient for the swap delay to be used directly by both the controlling server and responding server as there is no common point of reference. The swap delay may be needed by the controlling server so that it can establish the server timestamp of the swap point (swapTS_{controlling}). This may be calculated by adding the swap delay to C, the server timestamp of the first transport packet processed after the controlling agent provided T

swapTS_{controlling}=currentTS_{controlling}+swap delay.

The controlling server may then determine a “swap delta”, the difference between the swap time and the synchronization time (of S). The swap delta is

D_{swap}=swapTS_{controlling}−ATS_{controlling}.

The controlling server may then issue a command to the responding server to swap using the swap delta, D_{swap} (450).

The responding server may determine its swap time by computing the server timestamp of the transport stream packet after which the swap will take place (452) because the synchronization point S is a common point of reference.

swapTS_{responding}=ATS_{responding}+D_{swap}.

If a CA system was initialized, at this point the target server may have received the current CA parameters from the live server and the target server may have updated its internal state to be the same as that of the live server (454). Having agreed on the point after which the transport stream may be migrated from the live server to the target server (the swap point), it is then necessary to find the precise point at which the migration may occur, herein referred to as the splice point. As the live server is currently responsible for delivering the transport stream, it is responsible for determining the splice point (spliceTSₗᵢᵥₑ). When the target server (which may be the controlling or responding server) reaches a transport stream packet that has a server timestamp that is either greater than or equal to swapTS_{target}, the target server may optionally pause its processing for that transport stream until a message is received from the live server (458). Without pausing, the target server may overtake the position of the live server because of buffering differences. Meanwhile, the live server may continue processing but may search for the splice point (spliceTSₗᵢᵥₑ) which is the transport stream packet that has a server timestamp that is either greater than or equal to swapTSₗᵢᵥₑ and is the first in a UDP/IP datagram. In FIG. 5B, this is the server timestamp of the first packet 327 in the datagram that begins at N. From the splice point, the live server may calculate the splice delta

D_{splice}=spliceTSₗᵢᵥₑ−ATSₗᵢᵥₑ

and may send the splice delta to the target server (462). The target server may convert the splice delta into an actual splice point from the synchronization point (464)

spliceTS_{target}=D_{splice}+ATS_{target}.

Once the relative times have been determined the migration may proceed. The target server may wait for splice point N (472). If the target server optionally paused its processing, the output from the target server may be activated and the data no longer dropped after splice point N (474). The target server may begin filling its output buffer with the transport stream packet that has a timestamp that matches spliceTS_{target} (478). The live server may stop filling its output buffer from this transport stream packet onwards, i.e. spliceTSₗᵢᵥₑ≧swapTSₗᵢᵥₑ (482). As the output buffer of the target server fills, the output buffer of the live server will drain. Once the system latency time has elapsed, the swap will have completed.

As mentioned hereinabove, a further example of a suitable reference point may be the PTS value in a PES header 315 due to the frequency of the PTS, both its resolution and occurrence in the bitstream. There is a direct, 1:1 mapping between a single PTS and MPEG-2 transport stream packet (and hence server timestamp). As both the live server and target server are receiving identical data streams, both data streams may comprise identical time references in the PTS. The PTS may not be suitable if the transport stream were already encrypted.

Numerous specific details have been described in the preceding description to provide a thorough understanding of the invention. However, it will be understood by those of ordinary skill in the art that the present invention may not require all these specific details. In other instances, well-known methods, and/or components may not have been described in full detail so as not to obscure the present invention.

An embodiment of the present invention may include an apparatus for performing the operations described herein. Such an apparatus may be specially constructed or may comprise a general-purpose computer that is operated according to a computer program stored therein. Such a computer program may be stored in any appropriate computer readable storage medium.

It is appreciated that software components of the present invention may, if desired, be implemented in ROM (read only memory) form. The software components may generally be implemented in hardware, if desired, using conventional techniques.

It is appreciated that various features of the invention, which are, for clarity, described in the contexts of separate embodiments, may also be provided in combination in a single embodiment. Conversely, various features of the invention, which are, for brevity, described in the context of a single embodiment, may also be provided separately or in any suitable subcombination.

While certain features of the invention have been illustrated and described herein, many modifications, substitutions, changes, and equivalents will now occur to those of ordinary skill in the art. It should therefore be understood that the present invention is not limited by what has been particularly shown and described hereinabove. Rather the scope of the invention is defined only by the claims that follow:

1. A transport stream migration method comprising:
providing a live server and a target server;
the live server receiving a transport stream;
designating exactly one of the live server and the target server as a controlling server;
the controlling server receiving a migration instruction;
the target server receiving a copy of the transport stream;
negotiating a synchronization point by the live server and the target server; and
migrating output of the transport stream from the live server to the target server with respect to a time determined from the synchronization point negotiated.

2. The method according to claim 1 and further comprising:
initializing a conditional access system on the target server to decrypt and/or encrypt transport streams; and
updating conditional access parameters of the target server with conditional access parameters received from the live server.

3. The method according to claim 1 and wherein said negotiating comprises:
searching by the live server and the target server for suitable reference point values;
only if the live server is designated as the controlling server, designating the target server as the responding server;
only if the target server is designated as the controlling server, designating the live server as the responding server;
the responding server sending at least one proposed reference point value to the controlling server from among the suitable reference point values;
the controlling server informing the responding server of a chosen synchronization point chosen from among the at least one proposed reference point values; and
assigning the chosen synchronization point as the synchronization point.

4. The method according to claim 3 and wherein each of the at least one proposed reference point value comprises one of the following:
a program clock reference (PCR); and
a presentation timestamp (PTS).

5. The method according to claim 1 and further comprising the live server and the target server applying timestamps to each transport stream packet received based on the incoming transport bitrate.

6. The method according to claim 1 and further comprising:
determining a swap time by the controlling server,
sending a swap delta calculated from the swap time and the synchronization point from the controlling server to the responding server;
determining a swap time by the responding server from the received swap delta and the synchronization point;
the live server finding a first splice point and sending a splice delta to the target server computed from the splice point and the synchronization point; and
the target server computing a second splice point from the received splice delta and the synchronization point.

7. The method according to claim 6 and wherein the live server comprises a first output buffer and the target server comprises a second output buffer and said migrating further comprises:
the target server starting to fill the second output buffer from the second splice point; and
the live server stopping filling the first output buffer at the first splice point, thus allowing the output buffer of the live server to drain.

8. The method according to claim 1 and wherein the transport stream is an MPEG-2 compliant transport stream and wherein the method further comprises managing control word polarity.

9. The method according to claim 1 and wherein said migrating is of at least one transport stream, and the live server generates at least two transport streams from a single transport stream received.

10. A transport stream migration system comprising:
at least one live server to deliver a received transport stream;
at least one target server to take over delivery of a transport stream received by said at least one live server;
a transport stream splitter and switch unit to copy the received transport stream and control the delivery of the transport stream to said at least one live server and said at least one target server;
an Internet protocol (IP) switch to direct the output of said at least one live server and said at least one target server; and
a control unit to schedule a migration from said at least one live server to said at least one target server.

11. The system according to claim 10 and wherein said transport stream splitter and switch unit comprises at least one of the following:
at least one IP switch;
at least one asynchronous serial interface (ASI) splitter and at least one ASI switch; and
at least one ASI matrix.

12. The system according to claim 10 and wherein the received transport stream is a MPEG-2 transport stream.

13. The system according to claim 10 and wherein the migration from said at least one live server to said at least one target server begins with a first transport packet of a UDP/IP datagram.

14. A transport stream migration method comprising:
at least one live server receiving a transport stream;
scheduling a migration from the at least one live server to at least one target server;
copying the received transport stream and controlling the delivery of the transport stream and transport stream copy to the at least one live server and at the least one target server by a transport stream splitter and switch unit; and
directing the output of the at least one live server and the at least one target server by an Internet protocol (IP) switch.

15. The method according to claim 14 and wherein the transport stream splitter and switch unit comprises at least one of the following:
at least one IP switch;
at least one asynchronous serial interface (ASI) splitter and at least one ASI switch; and
at least one ASI matrix.

16. The method according to claim 14 and wherein the received transport stream is a MPEG-2 transport stream.

17. The method according to claim 14 and wherein the migration from the at least one live server to the at least one target server begins with a first transport packet of a UDP/IP datagram.

18. A transport stream migration system comprising:
a live server receiving a transport stream;
a target server receiving a copy of the transport stream, wherein exactly one of said live server and said target server is designated as a controlling server;
a control unit to issue a migration instruction to said controlling server;
a negotiator on said live server and said target server to control negotiation of a synchronization point between said live server and said target server; and
a migration controller on said live server and said target server to migrate output of the transport stream from said live server to said target server with respect to a time determined from the synchronization point negotiated.

19. The system according to claim 18 and further comprising a conditional access system on the target server to decrypt and/or encrypt transport streams with updated conditional access parameters received from said live server.

20. The system according to claim 18 and wherein said negotiator comprises:
a search unit to look for suitable reference point values;
a responding server, wherein:
only if said live server is designated as said controlling server, said target server is designated as the responding server; and
only if said target server is designated as said controlling server, said live server is designated as the responding server;
a communication unit on said responding server to send at least one proposed reference point value to said controlling server from among the suitable reference point values; and
a receiver on said target server to receive a chosen synchronization point chosen by said controlling server from among the at least one proposed reference point values.

21. The system according to claim 20 and wherein each of the at least one proposed reference point value comprises one of the following:
a program clock reference (PCR); and
a presentation timestamp (PTS).

22. The system according to claim 18 and wherein said live server and said target server apply timestamps to each transport stream packet received based on the incoming transport bitrate.

23. The system according to claim 18 and wherein:
said controlling server determines a first swap time;
said controlling server calculates a swap delta from said swap time and the synchronization point and sends said swap delta to said responding server;
said responding server computes a second swap time from said swap delta and the synchronization point;
said live server computes a splice delta from a first splice point and the synchronization point; and
said target server computes a second splice point from said splice delta and the synchronization point.

24. The system according to claim 23 and wherein said live server comprises a first output buffer and said live server stops filling said first output buffer from said first splice point, and said target server comprises a second output buffer and said target server starts to fill said second output buffer from said second splice point.

25. The system according to claim 18 and wherein the transport stream comprises an MPEG-2 compliant transport stream and the system further comprises a control word polarity manager.

26. The system according to claim 18 and wherein said migration controller controls the migration of at least one transport stream wherein said live server generates at least two transport streams from the single transport stream received.
